(19) United States
(12) Patent Application Publication
(10) Pub. No.: US 2010/0214357 A1
(43) Pub. Date: Aug. 26, 2010

(54) INKJET HEAD CLEANING APPARATUS, IMAGE RECORDING APPARATUS AND INKJET HEAD CLEANING METHOD

(76) Inventor: Noriaki MAIDA, Kanagawa-ken (JP)

Correspondence Address: BIRCH STEWART KOLASCH & BIRCH, PO BOX 747, FALLS CHURCH, VA, 22040-0747, US

(21) Appl. No.: 12/711,747

(22) Filed: Feb. 24, 2010

(30) Foreign Application Priority Data
Feb. 25, 2009 (JP) 2009-042991

(51) Int. Cl. B41J 2/165

(52) U.S. Cl. 347/28; 347/33

(57) ABSTRACT

The inkjet head cleaning apparatus includes: a cleaning liquid application device including a cleaning liquid nozzle which applies cleaning liquid to a liquid ejection surface of an inkjet head; a cleaning liquid supply device which supplies the cleaning liquid to the cleaning liquid nozzle; and a flow speed adjustment device which adjusts a flow speed of the cleaning liquid supplied from the cleaning liquid supply device to the cleaning liquid nozzle in such a manner that a pillar of the cleaning liquid emitted from the cleaning liquid nozzle makes contact with the nozzle surface of the inkjet head.

### BACKGROUND OF THE INVENTION

1. Field of the Invention

The present invention relates to an inkjet head cleaning apparatus, an image recording apparatus and an inkjet head cleaning method, and more particularly to technology for cleaning a liquid ejection surface of an inkjet head.

2. Description of the Related Art

As a general image recording apparatus, it is suitable to use an inkjet recording apparatus, which forms a desired image on a recording medium by ejecting and depositing colored inks from a plurality of nozzles provided in an inkjet head. If the inkjet head is operated for a long period of time, adhering matter such as solidified ink or paper dust from the recording medium, and the like, adhere to the nozzle surface. In particular, if adhering matter becomes attached to the vicinity of the nozzles and the nozzle apertures, this gives rise to deflection of the ejection direction of the ink ejected from the nozzles, or reduction in the ejection volume, and so on, and therefore an inkjet recording apparatus is composed in such a manner that cleaning of the nozzle surface is carried out appropriately.

Japanese Patent Application Publication No. 2000-094703 discloses a cleaning apparatus which applies a cleaning liquid in a non-contact fashion to an inkjet head, by rotating an application roller having a cylindrical shape which is immersed in the cleaning liquid. However, this cleaning apparatus requires the speed of rotation of the application roller to be high in order to provide the application roller with a coating layer of a certain thickness of the cleaning liquid. On the other hand, since the flow speed of the applied cleaning liquid becomes high if the speed of rotation of the application roller is high, and the flow speed of the cleaning liquid is greatest in the vicinity of the inkjet head, then there is a risk that the meniscus formed inside the nozzles arranged in the surface (nozzle surface) of the inkjet head will break down. If the meniscus breaks down, then this causes ejection failures and leads to decline in the printing performance. Furthermore, if the speed of rotation of the application roller is too high, then violent eddies are created in the cleaning liquid and stable application of the cleaning liquid becomes impossible. Consequently, there are limits on the thickness of the coating layer of the cleaning liquid for achieving stable application of the cleaning liquid (approximately 0.5 mm in the case of the cleaning apparatus described in Japanese Patent Application Publication No. 2000-094703). Therefore, it is necessary to very precisely adjust the clearance between the cleaning apparatus and the nozzle surface of the head, and sufficient attention must be given to the accuracy of assembly.

### SUMMARY OF THE INVENTION

The present invention has been contrived in view of these circumstances, an object thereof being to provide a head cleaning apparatus, an image recording apparatus and a head cleaning method, whereby cleaning liquid can be applied stably to a liquid ejection surface of an inkjet head.

In order to attain the aforementioned object, the present invention is directed to an inkjet head cleaning apparatus, comprising: a cleaning liquid application device including a cleaning liquid nozzle which applies cleaning liquid to a liquid ejection surface of an inkjet head; a cleaning liquid supply device which supplies the cleaning liquid to the cleaning liquid nozzle; and a flow speed adjustment device which adjusts a flow speed of the cleaning liquid supplied from the cleaning liquid supply device to the cleaning liquid nozzle in such a manner that a pillar of the cleaning liquid emitted from the cleaning liquid nozzle makes contact with the nozzle surface of the inkjet head.

According to the present invention, since the cleaning liquid is applied by bringing the pillar of the cleaning liquid into contact with the liquid ejection surface of the inkjet head, the flow speed of the cleaning liquid in the direction perpendicular to the liquid ejection surface is practically zero, and therefore breakdown of the meniscus inside the nozzles formed in the liquid ejection surface is prevented and stable printing performance of the inkjet head is maintained. Furthermore, by adjusting the flow speed of the cleaning liquid supplied to the cleaning liquid nozzle, it is possible readily to adjust the height of the pillar of the cleaning liquid, and therefore simplification of the assembly and adjustment of the maintenance unit can be expected.

### BRIEF DESCRIPTION OF THE DRAWINGS

FIG. 1 is a general schematic drawing of an inkjet image recording apparatus according to an embodiment of the present invention;

FIGS. 2A to 2C are plan view perspective diagrams showing embodiments of the inkjet head in FIG. 1;

FIG. 3 is a cross-sectional diagram showing the inner composition of an ink chamber unit;

FIG. 4 is a principal block diagram showing the system configuration of the inkjet image recording apparatus in FIG. 1;

FIG. 5 is a general schematic drawing of a head maintenance unit according to an embodiment of the present invention;

FIG. 6 is a general schematic drawing of a head cleaning unit (cleaning liquid application unit) according to an embodiment of the present invention;

FIG. 7 is a side view of the cleaning liquid application unit in FIG. 6;

FIG. 8 is a general schematic drawing showing the approximate composition of a further mode of the cleaning liquid application unit in FIG. 6;

FIG. 9 is a diagram for illustrating the arrangement of cleaning liquid nozzles in the cleaning liquid application unit in FIG. 6;

FIGS. 10A and 10B are diagrams for illustrating the height distribution of cleaning liquid pillars;

FIG. 11 is a cross-sectional perspective diagram of the cleaning liquid pillar generating unit in FIG. 6;

FIG. 12 is a diagram illustrating a nozzle arrangement for cancelling out height distribution of the cleaning liquid pillars; and

FIG. 13 is a diagram for describing a cleaning apparatus (cleaning liquid application unit) according to a modified embodiment of the present invention.

### DETAILED DESCRIPTION OF THE PREFERRED EMBODIMENTS

### Entire Configuration of Inkjet Recording Apparatus

First, an inkjet recording apparatus will be described as an embodiment of an image forming apparatus according to the present invention.

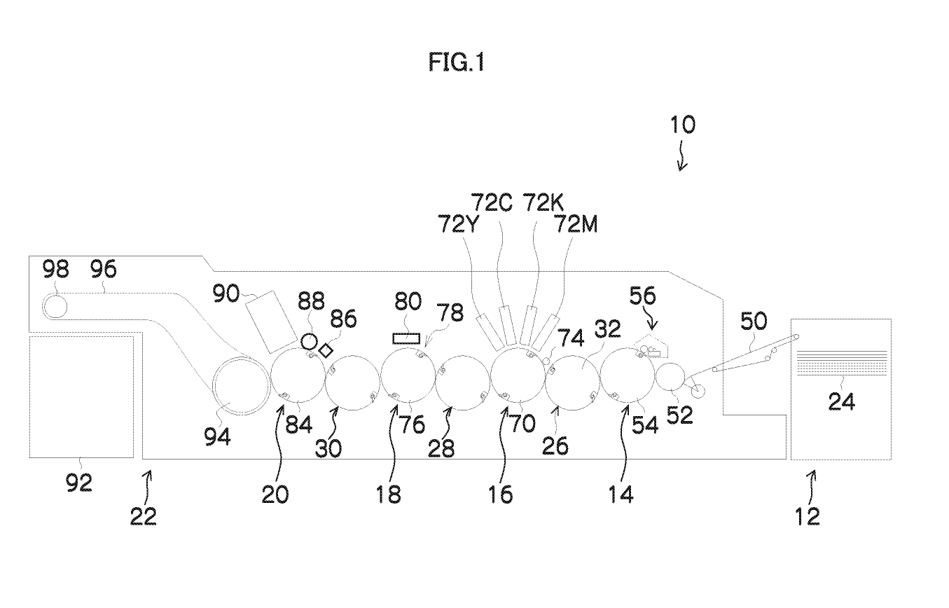

FIG. 1 is a structural diagram illustrating the entire configuration of an inkjet recording apparatus 10 according to an embodiment of the present invention. The inkjet recording apparatus 10 shown in the drawing is an recording apparatus in a two-liquid aggregating system of forming an image on a recording surface of a recording medium 24 by using ink (an aqueous ink) and a treatment liquid (aggregation treatment liquid). The inkjet recording apparatus 10 includes a paper feed unit 12, a treatment liquid application unit 14, an image formation unit 16, a drying unit 18, a fixing unit 20, and a discharge unit 22 as the main components. A recording medium 24 (paper sheets) is stacked in the paper feed unit 12, and the recording medium 24 is fed from the paper feed unit 12 to the treatment liquid application unit 14. A treatment liquid is applied to the recording surface in the treatment liquid application unit 14, and then a color ink is applied to the recording surface in the image formation unit 16. The image is fixed with the fixing unit 20 on the recording medium 24 onto which the ink has been applied, and then the recording medium is discharged with the discharge unit 22.

In the inkjet recording apparatus 10, intermediate conveyance units 26, 28 and 30 are provided between the units, and the recording medium 24 is transferred by these intermediate conveyance units 26, 28 and 30. Thus, a first intermediate conveyance unit 26 is provided between the treatment liquid application unit 14 and image formation unit 16, and the recording medium 24 is transferred from the treatment liquid application unit 14 to the image formation unit 16 by the first intermediate conveyance unit 26. Likewise, the second intermediate conveyance unit 28 is provided between the image formation unit 16 and the drying unit 18, and the recording medium 24 is transferred from the image formation unit 16 to the drying unit 18 by the second intermediate conveyance unit 28. Further, a third intermediate conveyance unit 30 is provided between the drying unit 18 and the fixing unit 20, and the recording medium 24 is transferred from the drying unit 18 to the fixing unit 20 by the third intermediate conveyance unit 30.

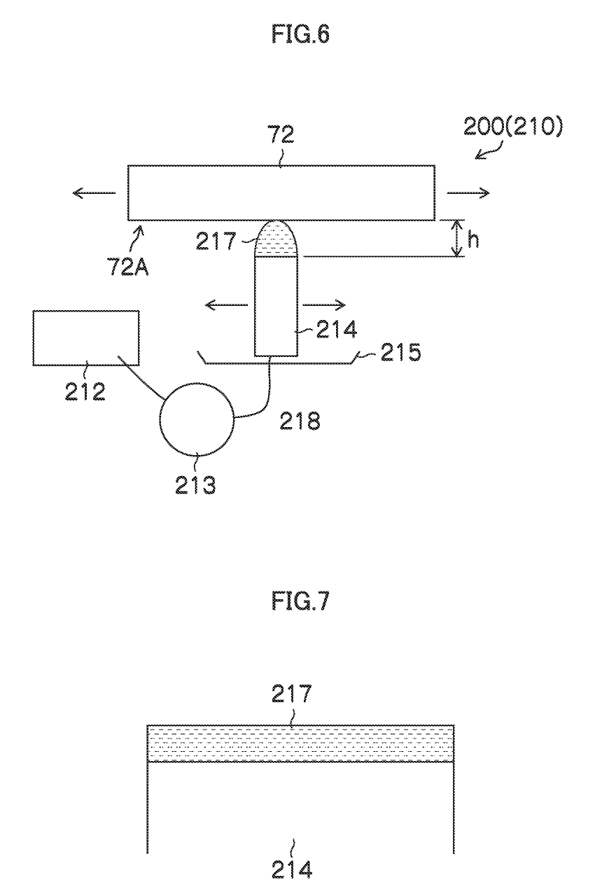

Although not shown in FIG. 1, the inkjet recording apparatus 10 is provided with a head cleaning unit 200 (see FIG. 6) which cleans inkjet heads 72M, 72K, 72C and 72Y arranged in the print unit 16.

Each unit (paper feed unit 12, treatment liquid application unit 14, image formation unit 16, drying unit 18, fixing unit 20, and discharge unit 22) of the inkjet recording apparatus 10 will be described below in greater details.

### <Paper Feed Unit>

The paper feed unit 12 feeds the recording medium 24 to the image formation unit 16. A paper feed tray 50 is provided in the paper feed unit 12, and the recording medium 24 is fed, sheet by sheet, from the paper feed tray 50 to the treatment liquid application unit 14.

### <Treatment Liquid Application Unit>

The treatment liquid application unit 14 is a mechanism that applies a treatment liquid to the recording surface of the recording medium 24. The treatment liquid includes a coloring material aggregating agent that causes the aggregation of a coloring material (pigment) included in the ink applied in the image formation unit 16, and the separation of the coloring material and a solvent in the ink is enhanced when the treatment liquid is brought into contact with the ink.

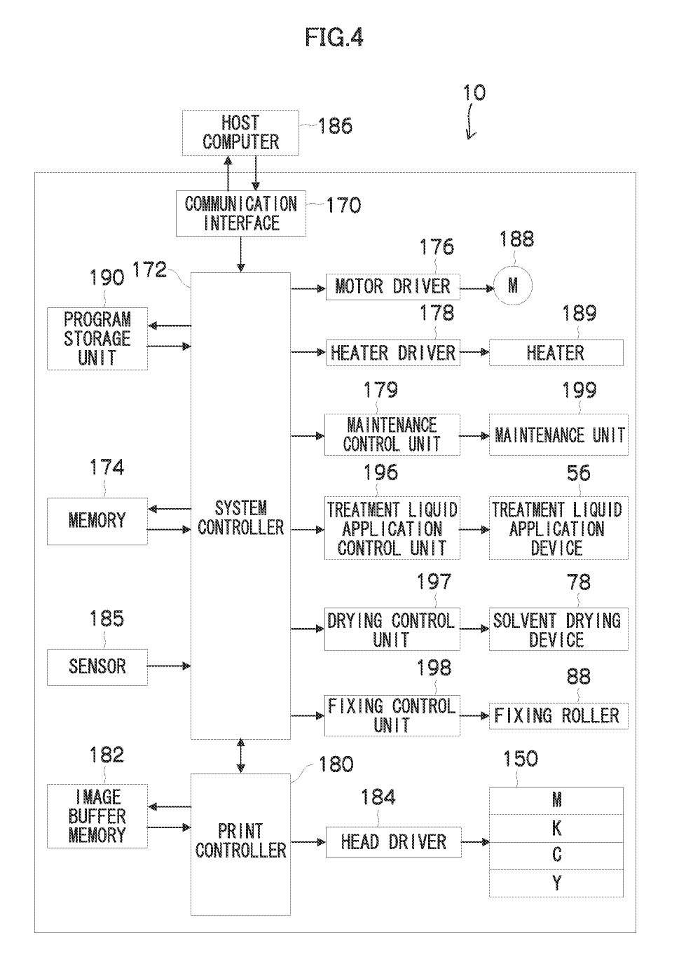

As shown in FIG. 1, the treatment liquid application unit 14 includes a paper transfer drum 52, a treatment liquid drum 54, and a treatment liquid application device 56. The paper transfer drum 52 is disposed between the paper feed tray 50 of the paper feed unit 12 and the treatment liquid drum 54. The rotation of the paper transfer drum 52 is driven and controlled by a below-described motor driver 176 (see FIG. 4). The recording medium 24 fed from the paper feed unit 12 is received by the paper transfer drum 52 and transferred to the treatment liquid drum 54. The below-described intermediate conveyance unit may be also provided instead of the paper transfer drum 52.

The treatment liquid drum 54 is a drum that holds and rotationally conveys the recording medium 24. The rotation of the treatment liquid drum 54 is driven and controlled by the below-described motor driver 176 (see FIG. 4). Further, the treatment liquid drum 54 is provided on the outer circumferential surface thereof with a hook-shaped holding device, by which the leading end of the recording medium 24 can be held. In a state in which the leading end of the recording medium 24 is held by the holding device, the treatment liquid drum 54 is rotated to rotationally convey the recording medium 24. In this case, the recording medium 24 is conveyed in a state where the recording surface thereof faces outward. The treatment liquid drum 54 may be provided with suction apertures on the outer circumferential surface thereof and connected to a suction device that performs suction from the suction apertures. As a result, the recording medium 24 can be held in a state of tight adherence to the outer circumferential surface of the treatment liquid drum 54.

The treatment liquid application device 56 is provided on the outside of the treatment liquid drum 54 opposite the outer circumferential surface thereof. The treatment liquid application device 56 applies the treatment liquid onto the recording surface of the recording medium 24. The treatment liquid application device 56 includes: a treatment liquid container, in which the treatment liquid to be applied is held; an anilox roller, a part of which is immersed in the treatment liquid held in the treatment liquid container; and a rubber roller, which is pressed against the anilox roller and the recording medium 24 that is held by the treatment liquid drum 54, so as to transfer the treatment liquid metered by the anilox roller 64 to the recording medium 24.

With the treatment liquid application device 56 of the above-described configuration, the treatment liquid is applied onto the recording medium 24, while being metered. In this case, it is preferred that the film thickness of the treatment liquid be sufficiently smaller than the diameter of ink droplets that are ejected from inkjet heads 72M, 72K, 72C and 72Y of the image formation unit 16. For example, when the ink droplet volume is 2 picoliters (pl), the average diameter of the droplet is 15.6 μm. In this case, when the film thickness of the treatment liquid is large, the ink dot will be suspended in the treatment liquid, without coming into contact with the surface of the recording medium 24. Accordingly, when the ink droplet volume is 2 pl, it is preferred that the film thickness of the treatment liquid be not more than 3 μm in order to obtain a landing dot diameter not less than 30 μm.

In the present embodiment, the application system using the roller is used to deposit the treatment liquid onto the recording surface of the recording medium 24; however, the present invention is not limited to this, and it is possible to employ a spraying method, an inkjet method, or other methods of various types. Furthermore, in a printing method that fixes ink droplets having been deposited on a recording medium from the inkjet heads 72M, 72K, 72C and 72Y of the print unit 16, by applying energy to the ink through heating, pressing, irradiation of radiation, or the like, the treatment liquid deposition unit 14 is omitted.

### <Image Formation Unit>

The image formation unit 16 is a mechanism which prints an image corresponding to an input image by ejecting and depositing droplets of ink by an inkjet method, and the image formation unit 16 includes an image formation drum 70, a paper pressing roller 74 and the inkjet heads 72M, 72K, 72C and 72Y. The inkjet heads 72M, 72K, 72C and 72Y correspond to inks of four colors: magenta (M), black (K), cyan (C) and yellow (Y), and are disposed in the order of description from the upstream side in the rotation direction of the image formation drum 70.

The image formation drum 70 is a drum that holds the recording medium 24 on the outer circumferential surface thereof and rotationally conveys the recording medium 24. The rotation of the image formation drum 70 is driven and controlled by the below-described motor driver 176 (see FIG. 4).

Further, the image formation drum 70 is provided on the outer circumferential surface thereof with a hook-shaped holding device, by which the leading end of the recording medium 24 can be held. In a state in which the leading end of the recording medium 24 is held by the holding device, the image formation drum 70 is rotated to rotationally convey the recording medium 24. In this case, the recording medium 24 is conveyed in a state where the recording surface thereof faces outward, and inks are deposited on the recording surface by the inkjet heads 72M, 72K, 72C and 72Y.

The paper pressing roller 74 is a guide member for causing the recording medium 24 to tightly adhere to the outer circumferential surface of the image formation drum 70, and is arranged so as to face the outer circumferential surface of the image formation drum 70. More specifically, the paper pressing roller 74 is disposed to the downstream side of the position where transfer of the recording medium 24 is received, and to the upstream side from the inkjet heads 72M, 72K, 72C and 72Y, in terms of the direction of conveyance of the recording medium 24 (the direction of rotation of the image formation drum 70).

When the recording medium 24 that has been transferred onto the image formation drum 70 from the intermediate conveyance unit 26 is rotationally conveyed in a state where the leading end portion of the recording medium 24 is held by the holding device, the recording medium 24 is pressed by the paper pressing roller 74 to tightly adhere to the outer circumferential surface of the image formation drum 70. When the recording medium 24 has been made to tightly adhere to the outer circumferential surface of the image formation drum 70 in this way, the recording medium 24 is conveyed to a print region directly below the inkjet heads 72M, 72K, 72C and 72Y in a state where the recording medium 24 does not float up at all from the outer circumferential surface of the image formation drum 70.

The inkjet heads 72M, 72K, 72C and 72Y are inkjet heads (inkjet heads) of the inkjet system of the full line type that have a length corresponding to the maximum width of the image formation region in the recording medium 24. A nozzle row is formed on the ink ejection surface of the inkjet head. The nozzle row has a plurality of nozzles arranged therein for discharging ink over the entire width of the image recording region. Each of the inkjet heads 72M, 72K, 72C and 72Y is fixedly disposed so as to extend in the direction perpendicular to the conveyance direction (rotation direction of the image formation drum 70) of the recording medium 24.

Furthermore, each of the inkjet heads 72M, 72K, 72C and 72Y is disposed at an inclination with respect to the horizontal, in such a manner that each of the nozzle surfaces of the inkjet heads 72M, 72K, 72C and 72Y is substantially parallel to the recording surface of the recording medium 24 held on the outer circumferential surface of the image formation drum 70.

Droplets of corresponding colored inks are ejected from the inkjet heads 72M, 72K, 72C and 72Y having the above-described configuration toward the recording surface of the recording medium 24 held on the outer circumferential surface of the image formation drum 70. As a result, the ink comes into contact with the treatment liquid that has been heretofore applied on the recording surface by the treatment liquid application unit 14, the coloring material (pigment) dispersed in the ink is aggregated, and a coloring material aggregate is formed. Therefore, the coloring material flow on the recording medium 24 is prevented and an image is formed on the recording surface of the recording medium 24. In this case, because the image formation drum 70 of the image formation unit 16 is structurally separated from the treatment liquid drum 54 of the treatment liquid application unit 14, the treatment liquid does not adhere to the inkjet heads 72M, 72K, 72C and 72Y, and the number of factors preventing the ejection of ink can be reduced.

In the present embodiment, the CMYK standard color (four colors) configuration is described, but combinations of ink colors and numbers of colors are not limited to that of the present embodiment, and if necessary, light inks, dark inks, and special color inks may be added. For example, a configuration is possible in which inkjet heads are added that eject light inks such as light cyan and light magenta. The arrangement order of color heads is also not limited.

### <Drying Unit>

The drying unit 18 dries water included in the solvent separated by the coloring material aggregation action. As shown in FIG. 1, the drying unit includes a drying drum 76 and a solvent dryer 78.

The drying drum 76 is a drum that holds the recording medium 24 on the outer circumferential surface thereof and rotationally conveys the recording medium 24. The rotation of the drying drum 76 is driven and controlled by the below-described motor driver 176 (see FIG. 4). Further, the drying drum 76 is provided on the outer circumferential surface thereof with a hook-shaped holding device, by which the leading end of the recording medium 24 can be held. In a state in which the leading end of the recording medium 24 is held by the holding device, the drying drum 76 is rotated to rotationally convey the recording medium. In this case, the recording medium 24 is conveyed in a state where the recording surface thereof faces outward. The drying treatment is carried out by the solvent dryer 78 with respect to the recording surface of the recording medium 24. The drying drum 76 may be provided with suction apertures on the outer circumferential surface thereof and connected to a suction device that performs suction from the suction apertures. As a result, the recording medium 24 can be held in a state of tight adherence to the outer circumferential surface of the drying drum 76.

The solvent dryer 78 is disposed in a position facing the outer circumferential surface of the drying drum 76, and includes a halogen heater 80. The halogen heater 80 is controlled to blow warm air at a prescribed temperature (for example, 50° C. to 70° C.) at a constant blowing rate (for example, 12 m³/min) toward the recording medium 24.

With the solvent dryer 78 of the above-described configuration, water included in the ink solvent on the recording surface of the recording medium 24 held by the drying drum 76 is evaporated, and drying treatment is performed. In this case, because the drying drum 76 of the drying unit 18 is structurally separated from the image formation drum 70 of the image formation unit 16, the number of ink non-ejection events caused by drying of the head meniscus portion by thermal drying can be reduced in the inkjet heads 72M, 72K, 72C and 72Y. Further, there is a degree of freedom in setting the temperature of the drying unit 18, and the optimum drying temperature can be set.

It is desirable that the curvature of the drying drum 76 is in the range of not less than 0.002 (1/mm) and not more than 0.0033 (1/mm). If the curvature of the drying drum 76 is less than 0.002 (1/mm), then even if the recording medium 24 is made to curve, an insufficient effect in correcting cockling of the recording medium 24 is obtained, and if the curvature exceeds 0.0033 (1/mm), then the recording medium 24 is curved more than necessary and does not return to its original shape, but rather is output to the stack in a curved state.

Furthermore, it is desirable that the surface temperature of the drying drum 76 is set to 50° C. or above. By heating from the rear surface of the recording medium 24, drying is promoted and breaking of the image during fixing can be prevented. In this case, more beneficial effects are obtained if a device for causing the recording medium 24 to tightly adhere to the outer circumferential surface of the drying drum 76 is provided. As a device for causing the recording medium 24 to tightly adhere in this way, it is possible to employ various methods, such as vacuum suction, electrostatic attraction, or the like.

There are no particular restrictions on the upper limit of the surface temperature of the drying drum 76, but from the viewpoint of the safety of maintenance operations such as cleaning the ink adhering to the surface of the drying drum 76 (namely, preventing burns due to high temperature), desirably, the surface temperature of the drying drum 76 is not higher than 75° C. (and more desirably, not higher than 60° C.).

By holding the recording medium 24 in such a manner that the recording surface thereof is facing outward on the outer circumferential surface of the drying drum 76 having this composition (in other words, in a state where the recording surface of the recording medium 24 is curved in a convex shape), and drying while conveying the recording medium in rotation, it is possible to prevent the occurrence of wrinkles or floating up of the recording medium 24, and therefore drying non-uniformities caused by these phenomena can be prevented reliably.

### <Fixing Unit>

The fixing unit 20 includes a fixing drum 84, a halogen heater 86, a fixing roller 88, and an inline sensor 90. The halogen heater 86, the fixing roller 88, and the inline sensor 90 are arranged in positions opposite the outer circumferential surface of the fixing drum 84 in this order from the upstream side in the rotation direction (counterclockwise direction in FIG. 1) of the fixing drum 84.

The fixing drum 84 a drum that holds the recording medium 24 on the outer circumferential surface thereof and rotationally conveys the recording medium 24. The rotation of the fixing drum 84 is driven and controlled by the below-described motor driver 176 (see FIG. 4). The fixing drum 84 has a hook-shaped holding device, and the leading end of the recording medium 24 can be held by this holding device. The recording medium 24 is rotationally conveyed by rotating the fixing drum 84 in a state in which the leading end of the recording medium 24 is held by the holding device. In this case, the recording medium 24 is conveyed in a state where the recording surface thereof faces outward, and the preheating by the halogen heater 86, the fixing treatment by the fixing roller 88 and the inspection by the inline sensor 90 are performed with respect to the recording surface. The fixing drum 84 may be provided with suction apertures on the outer circumferential surface thereof and connected to a suction device that performs suction from the suction apertures. As a result, the recording medium 24 can be held in a state of tight adherence to the outer circumferential surface of the fixing drum 84.

The halogen heater 86 is controlled to a prescribed temperature (for example, 180° C.), by which the preheating is performed with respect to the recording medium 24.

The fixing roller 88 is a roller member which applies heat and pressure to the dried ink to melt and fix the self-dispersible polymer particles in the ink so as to transform the ink into the film. More specifically, the fixing roller 88 is arranged so as to be pressed against the fixing drum 84, and a nip roller is configured between the fixing roller 88 and the fixing drum 84. As a result, the recording medium 24 is squeezed between the fixing roller 88 and the fixing drum 84, nipped under a prescribed nip pressure (for example, 0.15 MPa), and subjected to fixing treatment.

Further, the fixing roller 88 is configured by a heating roller in which a halogen lamp is incorporated in a metal pipe, for example made from aluminum, having good thermal conductivity and the rollers are controlled to a prescribed temperature (for example 60° C. to 80° C.). Where the recording medium 24 is heated with the heating roller, thermal energy not lower than a Tg temperature (glass transition temperature) of a latex included in the ink is applied and latex particles are melted. As a result, fixing is performed by penetration into the projections-recessions of the recording medium 24, the projections-recessions of the image surface are leveled out, and gloss is obtained.

The fixing unit 20 is provided with the single fixing roller 88 in the above-described embodiment; however, it is possible that a plurality of fixing rollers 88 depending on the thickness of image layer and Tg characteristic of latex particles. Furthermore, the surface of the fixing drum 84 may be controlled to a prescribed temperature (for example 60° C.).

On the other hand, the inline sensor 90 is a measuring device which measures the check pattern, moisture amount, surface temperature, gloss, and the like of the image fixed to the recording medium 24. A CCD sensor or the like can be used for the inline sensor 90.

With the fixing unit 20 of the above-described configuration, the latex particles located within a thin image layer formed in the drying unit 18 are melted by application of heat and pressure by the fixing roller 88. Thus, the latex particles can be reliably fixed to the recording medium 24. In addition, with the fixing unit 20, the fixing drum 84 is structurally separated from other drums. Therefore, the temperature of the fixing unit 20 can be freely set separately from the image formation unit 16 and the drying unit 18.

In particular, similarly to the drying drum 76 described above, the fixing drum 84 used in the present embodiment is constituted of a rotating conveyance body having a prescribed curvature and a surface temperature set to a prescribed temperature, and desirably, the curvature of the fixing drum 84 is in a range of not less than 0.002 (1/mm) and not more than 0.0033 (1/mm) or lower. If the curvature of the fixing drum 84 is less than 0.002 (1/mm), then even if the recording medium 24 is made to curve, an insufficient effect in correcting cockling of the medium is obtained, and if the curvature exceeds 0.0033 (1/mm), then the recording medium 24 is curved more than necessary and does not return to its original shape, but rather is output to the stack in a curved state.

It is desirable that the surface temperature of the fixing drum 84 is set to 50° C. or above. Drying is promoted by heating the recording medium 24 held on the outer circumferential surface of the fixing drum 84 from the rear surface, and therefore breaking of the image during fixing can be prevented, and furthermore, the strength of the image can be increased by the effects of the increased temperature of the image.

There are no particular restrictions on the upper limit of the surface temperature of the fixing drum 84, but desirably, it is set to 75° C. or lower (and more desirably, 60° C. or lower), from the viewpoint of maintenance characteristics.

Moreover, it is desirable that the fixing roller 88 used in the present embodiment has a surface hardness of not higher than 71°. By making the surface of the fixing roller 88, which is a heating and pressing member, softer, it is possible to expect a beneficial effect in the fixing roller following the indentations which occur in the recording medium 24 as a result of cockling, then it is possible to prevent the occurrence of fixing non-uniformities.

Furthermore, it is desirable to achieve a state where the moisture in the image has been evaporated off and the high-boiling-point organic solvent has been concentrated to a suitable concentration in the image (in other words, a state where the high-boiling-point organic solvent in the image remains at a rate of 4% or more of the ink droplet ejection volume), since the image deforms more readily with respect to the surface of the fixing roller (heating and pressing member) 88 during fixing, while having sufficient strength to avoid breaking of the image. Moreover, if a binder component is contained in the image, then it is desirable to preheat the image, so that the image can be expected to similarly follow the surface of the fixing roller 88, and fixing non-uniformities can be prevented yet more effectively.

Here, the “state where the high-boiling-point organic solvent in the image remains at a rate of 4% or more of the ink droplet ejection volume” means that the ratio of the remaining amount of high-boiling-point organic solvent in the image present on the surface of the recording medium with respect to the ink droplet ejection volume at the time of the fixing process is 4% or above.

By holding the recording medium 24 with the recording surface thereof facing outward on the outer circumferential surface of the fixing drum 84 having this composition (in other words, in a state where the recording surface of the recording medium 24 is curved in a convex shape), and heating and pressing to fix the image while conveying the recording medium in rotation, then even in a state where the moisture is not completely dried off and some degree of cockling is liable to occur, this cockling can be rectified.

Furthermore, since fixing can be carried out by the fixing roller 88 in a state where the surface of the recording medium 24 is pulled and stretched against the force that seeks to create indentations in the surface (recording surface) of the recording medium 24 due to the swelling of the pulp fibers, and hence the indentations caused by cockling have been alleviated and flattened, then it is possible to prevent the occurrence of fixing non-uniformities caused by cockling.

### <Discharge Unit>

As shown in FIG. 1, the discharge unit 22 is provided after the fixing unit 20. The discharge unit 22 includes a discharge tray 92, and a transfer body 94, a conveying belt 96, and a tension roller 98 are provided between the discharge tray 92 and the fixing drum 84 of the fixing unit 20 so as to face the discharge tray 92 and the fixing drum 84. The recording medium 24 is fed by the transfer body 94 onto the conveying belt 96 and discharged onto the discharge tray 92.

### <Intermediate Conveyance Unit>

The structure of the first intermediate conveyance unit 26 will be described below. The second intermediate conveyance unit 28 and the third intermediate conveyance unit 30 are configured identically to the first intermediate conveyance unit 26 and the explanation thereof will be omitted.

The first intermediate conveyance unit 26 is provided with an intermediate conveyance body 32, which is a drum for receiving the recording medium 24 from a drum of a previous stage, rotationally conveying the recording medium 24, and transferring it to a drum of the subsequent stage, and is mounted to be capable of rotating freely. The intermediate conveyance body 32 is rotated by a motor 188 (not shown in FIG. 1 and shown in FIG. 4), and the rotation thereof is driven and controlled by the below-described motor driver 176 (see FIG. 4). Further, the intermediate conveyance body 32 is provided on the outer circumferential surface thereof with a hook-shaped holding device, by which the leading end of the recording medium 24 can be held. In a state in which the leading end of the recording medium 24 is held by the holding device, the intermediate conveyance body 32 is rotated to rotationally convey the recording medium 24. In this case, the recording medium 24 is conveyed in a state where the recording surface thereof faces inward, whereas the non-recording surface thereof faces outward.

The recording medium 24 conveyed by the first intermediate conveyance unit 26 is transferred to a drum of the subsequent stage (that is, the image formation drum 70). In this case, the transfer of the recording medium 24 is performed by synchronizing the holding device of the intermediate conveyance unit 26 and the holding device (the gripper 102) of the image formation unit 16. The transferred recording medium 24 is held by the image formation drum 70 and rotationally conveyed.

### <Structure of Inkjet Heads>

Next, the structure of the inkjet heads is described. The inkjet heads 72M, 72K, 72C and 72Y for the respective colored inks have the same structure, and a reference numeral 150 is hereinafter designated to any of the inkjet heads (hereinafter also referred to simply as the heads).

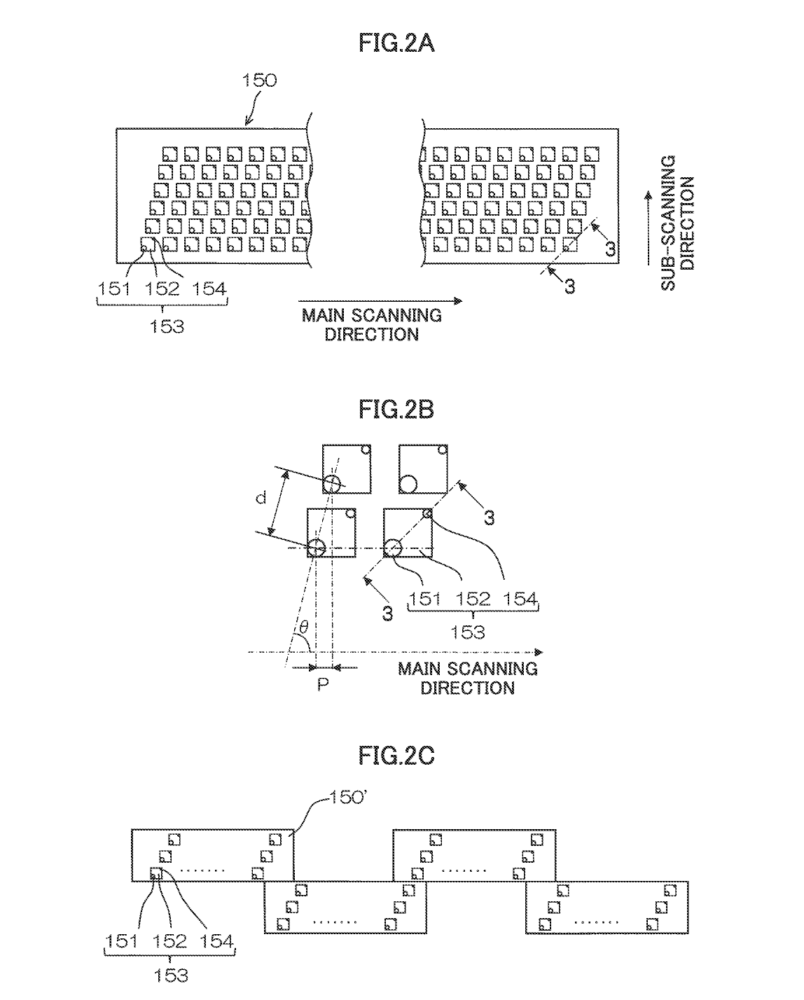

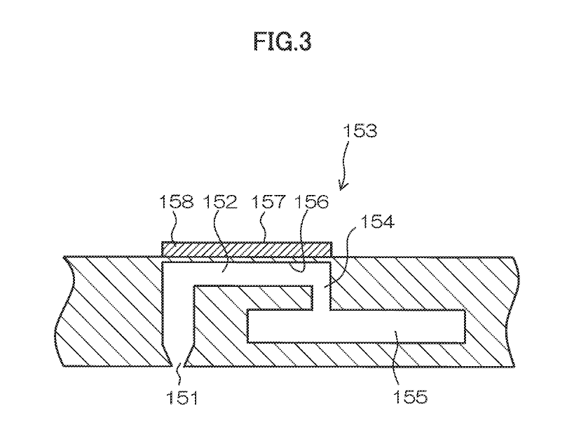

FIG. 2A is a perspective plan view showing an embodiment of the configuration of the head 150, FIG. 2B is an enlarged view of a portion thereof, and FIG. 2C is a perspective plan view showing another embodiment of the configuration of the head 150. FIG. 3 is a cross-sectional view taken along the line 3-3 in FIGS. 2A and 2B, showing the inner structure of an ink chamber unit in the head 150.

The nozzle pitch in the head 150 should be minimized in order to maximize the density of the dots printed on the surface of the recording medium 24. As shown in FIGS. 2A and 2B, the head 150 according to the present embodiment has a structure in which a plurality of ink chamber units (i.e., droplet ejection units serving as recording units) 153, each having a nozzle 151 forming an ink ejection aperture, a pressure chamber 152 corresponding to the nozzle 151, and the like, are disposed two-dimensionally in the form of a staggered matrix, and hence the effective nozzle interval (the projected nozzle pitch) as projected in the lengthwise direction of the head 150 (the main scanning direction: the direction perpendicular to the conveyance direction of the recording medium 24) is reduced and high nozzle density is achieved.

The mode of forming one or more nozzle rows through a length corresponding to the entire width of the recording medium 24 in the main scanning direction substantially perpendicular to the conveyance direction of the recording medium 24 (the sub-scanning direction) is not limited to the embodiment described above. For example, instead of the configuration in FIG. 2A, as shown in FIG. 2C, a line head having nozzle rows of a length corresponding to the entire width of the recording medium 24 can be formed by arranging and combining, in a staggered matrix, short head blocks 150′ having a plurality of nozzles 151 arrayed in a two-dimensional fashion. Furthermore, although not shown in the drawings, it is also possible to compose a line head by arranging short heads in one row.

The planar shape of the pressure chamber 152 provided for each nozzle 151 is substantially a square, and the nozzle 151 and an ink supply port 154 are disposed in both corners on a diagonal line of the square. The shape of the pressure chamber 152 is not limited to that of the present embodiment, and a variety of planar shapes, for example, a polygon such as a rectangle (rhomb, rectangle, etc.), a pentagon and a heptagon, a circle, and an ellipse can be employed. Each pressure chamber 152 is connected to a common channel 155 through the supply port 154. The common channel 155 is connected to an ink tank (not shown), which is a base tank for supplying ink, and the ink supplied from the ink tank is delivered through the common flow channel 155 to the pressure chambers 152.

A piezoelectric element 158 provided with an individual electrode 157 is bonded to a diaphragm 156, which forms a face (the upper face in FIG. 3) of the pressure chamber 152 and also serves as a common electrode. When a drive voltage is applied to the individual electrode 157, the piezoelectric element 158 is deformed, the volume of the pressure chamber 152 is thereby changed, and the ink is ejected from the nozzle 151 by the variation in pressure that follows the variation in volume. When the piezoelectric element 158 returns to the original state after the ink has been ejected, the pressure chamber 152 is refilled with new ink from the common channel 155 through the supply port 154.

The present embodiment applies the piezoelectric elements 158 as ejection power generation devices to eject the ink from the nozzles 151 arranged in the head 150; however, instead, a thermal system that has heaters within the pressure chambers 152 to eject the ink using the pressure resulting from film boiling by the heat of the heaters can be applied.

As shown in FIG. 2B, the high-density nozzle head according to the present embodiment is achieved by arranging the plurality of ink chamber units 153 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which the ink chamber units 153 are arranged at a uniform pitch d in line with a direction forming the angle of θ with respect to the main scanning direction, the pitch P of the nozzles projected so as to align in the main scanning direction is d×cos θ, and hence the nozzles 151 can be regarded to be equivalent to those arranged linearly at a fixed pitch P along the main scanning direction. Such configuration results in a nozzle structure in which the nozzle row projected in the main scanning direction has a high nozzle density of up to 2,400 nozzles per inch.

When implementing the present invention, the arrangement structure of the nozzles is not limited to the embodiments shown in the drawings, and it is also possible to apply various other types of nozzle arrangements, such as an arrangement structure having one nozzle row in the sub-scanning direction.

Furthermore, the scope of application of the present invention is not limited to a printing system based on the line type of head, and it is also possible to adopt a serial system where a short head that is shorter than the breadthways dimension of the recording medium 24 is moved in the breadthways direction (main scanning direction) of the recording medium 24, thereby performing printing in the breadthways direction, and when one printing action in the breadthways direction has been completed, the recording medium 24 is moved through a prescribed amount in the sub-scanning direction perpendicular to the breadthways direction, printing in the breadthways direction of the recording medium 24 is carried out in the next printing region, and by repeating this sequence, printing is performed over the whole surface of the printing region of the recording medium 24.

### Description of Control System

FIG. 4 is a block diagram of the main portion of a system configuration of the inkjet recording apparatus 10. The inkjet recording apparatus 10 includes a communication interface 170, a system controller 172, a memory 174, the motor driver 176, a heater driver 178, a maintenance control unit 179, a printing control unit 180, an image buffer memory 182, a head driver 184, a sensor 185, a program storage unit 190, a treatment liquid application control unit 196, a drying control unit 197, and a fixing control unit 198.

The communication interface 170 is an interface unit that receives image data sent from a host computer 186. A serial interface such as USB (Universal Serial Bus), IEEE 1394, Ethernet, and a wireless network, or a parallel interface such as Centronix can be applied as the communication interface 170. A buffer memory (not shown) may be installed in the part of the interface to increase the communication speed. The image data sent from the host computer 186 are introduced into the inkjet recording apparatus 10 through the communication interface 170 and temporarily stored in the memory 174.

The memory 174 is a storage device that temporarily stores the images inputted through the communication interface 170 and reads/writes the data via the system controller 172. The memory 174 is not limited to a memory composed of semiconductor elements and may use a magnetic medium such as a hard disk.

The system controller 172 includes a central processing unit (CPU) and a peripheral circuitry thereof, functions as a control device that controls the entire inkjet recording apparatus 10 according to a predetermined program, and also functions as an operational unit that performs various computations. Thus, the system controller 172 controls various units such as the communication interface 170, the memory 174, the motor driver 176, the heater driver 178, the maintenance control unit 179, the treatment liquid application control unit 196, the drying control unit 197 and the fixing control unit 198, performs communication control with the host computer 180, performs read/write control of the memory 174, and also generates control signals for controlling the various units.

Programs that are executed by the CPU of the system controller 172 and various data necessary for performing the control are stored in the memory 174. The memory 174 may be a read-only storage device or may be a writable storage device such as EEPROM. The memory 174 can be also used as a region for temporary storing image data, a program expansion region, and a computational operation region of the CPU.

Various control programs are stored in the program storage unit 190, and a control program is read out and executed in accordance with commands from the system controller 172. The program storage unit 190 may use a semiconductor memory, such as a ROM, EEPROM, or a magnetic disk, or the like. The program storage unit 190 may be provided with an external interface, and a memory card or PC card may also be used. Naturally, a plurality of these storage media may also be provided. The program storage unit 190 may also be combined with a storage device for storing operational parameters, and the like (not shown).

The motor driver 176 drives a motor 188 in accordance with commands from the system controller 172. In FIG. 4, the plurality of motors disposed in the respective sections of the inkjet recording apparatus 10 are represented by the reference numeral 188. For example, the motor 188 shown in FIG. 4 includes the motors that drive the paper transfer drum 52, the treatment liquid drum 54, the image formation drum 70, the drying drum 76, the fixing drum 84 and the transfer body 94 shown in FIG. 1, and the motors that drive the intermediate conveyance bodies 32 in the first, second and third intermediate conveyance units 26, 28 and 30.

The heater driver 178 is a driver that drives the heater 189 in accordance with commands from the system controller 172. In FIG. 4, the plurality of heaters disposed in the inkjet recording apparatus 10 are represented by the reference numeral 189. For example, the heater 189 shown in FIG. 4 includes the halogen heaters 80 in the solvent dryer 78 arranged in the drying unit 18 shown in FIG. 1, and the heaters that heat the surfaces of the drying drum 76 and the fixing drum 84 shown in FIG. 1.

The treatment liquid application control unit 196, the drying control unit 197 and the fixing control unit 198 control the operations of the treatment liquid application device 56, the solvent dryer 78 and the fixing roller 88, respectively, in accordance with commands from the system controller 172.

The printing control unit 180 has a signal processing function for performing a variety of processing and correction operations for generating signals for print control from the image data within the memory 174 according to control of the system controller 172, and supplies the generated printing data (dot data) to the head driver 184. The required signal processing is implemented in the printing control unit 180, and the ejection amount and ejection timing of droplets in the heads 150 are controlled through the head driver 184 based on the image data. As a result, the desired dot size and dot arrangement are realized.

The printing control unit 180 is provided with the image buffer memory 182, and data such as image data or parameters are temporarily stored in the image buffer memory 182 during image data processing in the printing control unit 180. A mode is also possible in which the printing control unit 180 and the system controller 172 are integrated and configured by one processor.

The head driver 184 generates drive signals for driving the piezoelectric elements 158 of the heads 150, on the basis of the dot data supplied from the print controller 180, and drives the piezoelectric elements 158 by applying the generated drive signals to the piezoelectric elements 158. A feedback control system for maintaining constant drive conditions in the inkjet heads 150 may be included in the head driver 184 shown in FIG. 4.

The sensor 185 represents the sensors disposed in the respective sections of the inkjet recording apparatus 10. For example, the sensor 185 includes the inline sensor 90 shown in FIG. 1, temperature sensors, position determination sensors, and pressure sensors. The output signals of the sensor 185 are sent to the system controller 172, and the system controller 172 controls the respective sections of the inkjet recording apparatus 10 by sending the command signals to the respective sections in accordance with the output signals of the sensor 185.

The maintenance control unit 179 is a processing block that controls a head maintenance unit 199, which carries out maintenance of the inkjet head 72 (any of inkjet heads 72M, 72K, 72C and 72Y shown in FIG. 1), in accordance with a control signal sent from the system controller 172. The head maintenance unit 199 shown in FIG. 4 includes the head cleaning unit 200 (see FIG. 6), which cleans a nozzle surface 72A of the inkjet head 72.

The details of control of the head maintenance unit 199 and the head cleaning unit 200 by the maintenance control unit 179 are described hereinafter.

### Description of Maintenance Unit

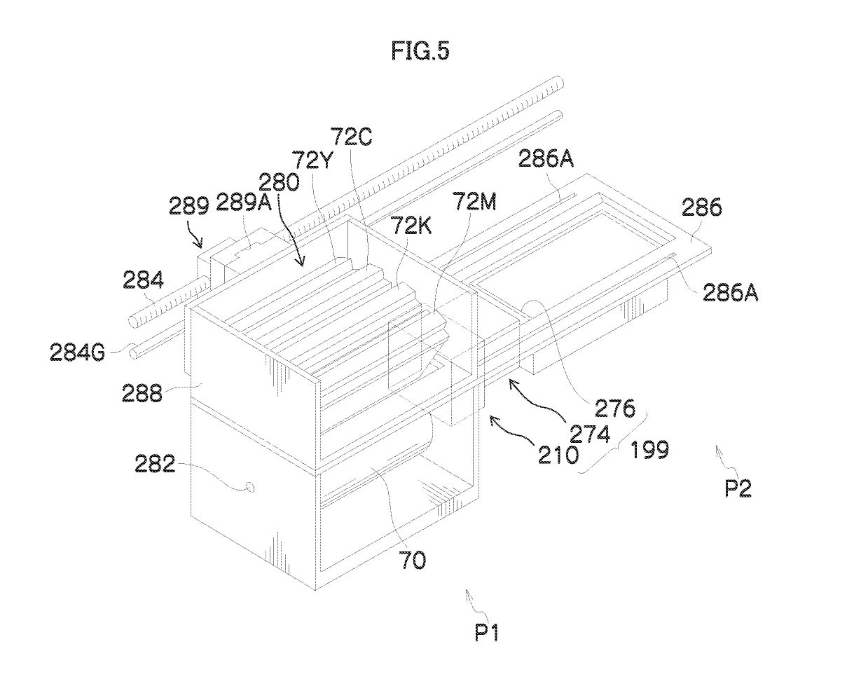

FIG. 5 is a perspective diagram of the head maintenance unit 199 arranged adjacently to the print unit 16. As shown in FIG. 5, the head maintenance unit 199 for carrying out maintenance processing of the inkjet heads 72M, 72K, 72C and 72Y is arranged on the outside of the image formation drum 70 of the print unit 16, adjacently to the image formation drum 70 in the axial direction of the image formation drum 70.

The head maintenance unit 199 is provided with a cleaning liquid application unit 210, a wiping unit 274 and a nozzle cap 276 disposed in this order from the side near the image formation drum 70.

A head unit 280 mounted with ink droplet ejection heads 72M, 72K, 72C and 72Y corresponding to the respective colors is engaged to a ball screw 284, which is disposed in parallel with the rotational axle 282 of the image formation drum 70. A guide shaft 284G is disposed in parallel with the ball screw 284, on the lower side of the ball screw 284, and the head unit 280 engages slidably with this guide shaft 284G. A guide rail member 286 having guide grooves 286A, which guide the movement of the head unit 280, is disposed in parallel with the ball screw 284, on the lower side of the head unit 280.

The head unit 280 has a frame body 288, which integrally holds the inkjet heads 72M, 72K, 72C and 72Y. Engaging parts (not shown) are projectingly formed on the lower surface of the frame body 288, and slidably engage with the guide grooves 286A, whereby the head unit 280 is able to move by being guided by the guide grooves 286A.

As shown in FIG. 5, the ball screw 284, the guide shaft 284G and the guide rail member 286 are arranged extending in the axial direction of the image formation drum 70 through a prescribed length, in such a manner that the head unit 280 can be moved from an image forming position P1 above the image formation drum 70 to a maintenance position P2 facing the nozzle cap 276.

The ball screw 284 is rotated by a drive device such as a motor (not shown), and due to this rotation, the head unit 280 is moved between the image forming position P1 and the maintenance position P2. Furthermore, the head unit 280 can be moved in a direction away from the image formation drum 70 or in a direction toward the image formation drum 70, by means of an upward/downward movement mechanism (not shown).

The height of the head unit 280 with respect to the surface of the image formation drum 70 (namely, the clearance between the recording surface of the recording medium 24 and the respective inkjet heads 72M, 72K, 72C and 72Y) is controlled in accordance with the thickness of the recording medium 24 used. Furthermore, if a jam, or the like, occurs during conveyance of the recording medium, then the head unit 280 can be moved upward in FIG. 5 and thereby withdrawn from the prescribed height position during image formation.

As shown in FIG. 5, a coupling portion 289 between the frame body 288 of the head unit 280 and the ball screw 284 and the guide shaft 284G employs a linearly movable engagement structure 289A, which guides the upward and downward movement of the head unit 280.

### Description of Head Cleaning Unit

### <General Composition of Head Cleaning Unit>

The head cleaning unit 200 including the cleaning liquid application unit 210 and the wiping unit 274 shown in FIG. 5 is hereby described.

FIG. 6 is a general schematic drawing of the head cleaning unit 200, viewed from the breadthways direction (the sub-scanning direction) of a full line type of inkjet head 72, and the direction perpendicular to the sheet of the drawing is the breadthways direction of the inkjet head 72 (the recording medium conveyance direction, the sub-scanning direction).

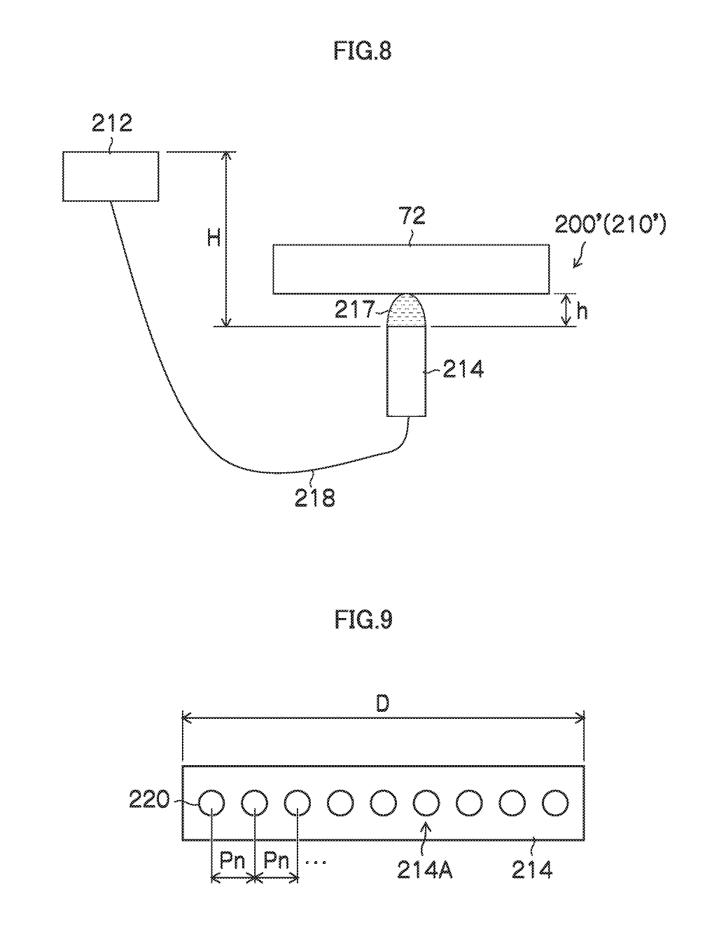

The cleaning unit 200 includes the cleaning liquid application unit 210 and the wiping unit 274 (not shown in FIG. 6, see FIG. 5). The cleaning liquid application unit 210 is provided with a cleaning liquid tank 212, a cleaning liquid pump 213, a cleaning liquid pillar generation unit 214 and a liquid receptacle 215. The cleaning liquid application unit 210 generates pillars of the cleaning liquid by ejecting a small amount of the cleaning liquid from a plurality of cleaning liquid nozzles 220 (see FIG. 9) arranged in a line at a position facing the nozzle surface 72A of the inkjet head 72, whereby the cleaning liquid application unit 200 applies the cleaning liquid to the inkjet head 72 in a non-contact fashion. The cleaning liquid uses a special liquid having higher cleaning effects, separately from the liquid (ink) that is ejected from the inkjet head 72. For example, it is possible to use a cleaning liquid containing a solvent, such as DEGmBE (diethylene glycol monobutyl ether) as the cleaning liquid.

The cleaning liquid pillar generation unit 214 has ejection ports (the cleaning liquid nozzles 220 shown in FIG. 9) facing upward so as to be able to create pillars of the cleaning liquid 217 toward the nozzle surface 72A of the head 72, and the cleaning liquid pillar generation unit 214 is disposed at a position in the vicinity of the nozzle surface 72A so as to guarantee a prescribed clearance for avoiding contact with the nozzle surface 72A when opposing the nozzle surface 72A.

The interval between the cleaning liquid pillar generation unit 214 and the nozzle surface 72A when the cleaning liquid pillar generation unit 214 faces the nozzle surface 72A is sufficient to be able to maintain the cleaning liquid pillars 217 which make contact with the nozzle surface 72A, and the interval is set to approximately 1 mm to 2 mm, for example. A suitable interval is designed in accordance with the properties (e.g., viscosity, surface tension) of the cleaning liquid, and the head movement speed, and the like.

When the cleaning liquid pump 213 is driven and a small amount of the cleaning liquid is supplied to the cleaning liquid pillar generation unit 214 from the cleaning liquid tank 212 through the supply channel 218, the cleaning liquid pillars 217 are formed. By adjusting the flow speed of the cleaning liquid by controlling the output (driving speed) of the cleaning liquid pump 213, it is possible to control the height h of the cleaning liquid pillars 217. Therefore, by making the height h of the cleaning liquid pillars 217 slightly greater than the clearance between the cleaning liquid pillar generation unit 214 and the nozzle surface 72A, it is possible to achieve stable application of the cleaning liquid corresponding to the overlapped volume, by means of a non-contact method. By suitably adjusting the height h of the cleaning liquid pillars 217, it is possible to adjust the volume of the cleaning liquid applied to the nozzle surface 72A.

FIG. 7 is a diagram showing the cleaning liquid pillar generation unit 214 in FIG. 6 as viewed from the breadthways direction (the sub-scanning direction) of the inkjet head 72. In the cleaning liquid pillar generation unit 214, the plurality of cleaning liquid nozzles 220 (see FIG. 9) are arranged through a length corresponding to the breadth of the inkjet head 72. It is then possible to apply the cleaning liquid to the whole of the nozzle surface 72A by moving the inkjet head 72 and the cleaning liquid pillar generation unit 214 relatively just once.

The cleaning liquid pillars 217 emitted from mutually adjacent cleaning liquid nozzles unite together and form a liquid wall overall, which makes contact with the nozzle surface 72A. The cleaning liquid pillars 217 are formed on the exterior of the cleaning liquid nozzles 220 in a state of being connected to, rather than separated from, the cleaning liquid inside the cleaning liquid pillar generation unit 214. When the top end portion of the cleaning liquid pillar 217 makes contact with the nozzle surface 72A, the surface free energy of the nozzle surface 72A acts in such a manner that a part of the top end portion of the cleaning liquid pillar 217 separates off and adheres to the nozzle surface 72A.

The cleaning liquid applied to the nozzle surface 72A is removed using a wiping unit 274 (see FIG. 5) when a prescribed time period has elapsed after the application. It is desirable that the wiping unit 274 uses a web made of cloth as a member that wipes the nozzle surface 72A. For the web, it is suitable to use, for example, a cloth material made of polyester or polypropylene fibers and having indentations in the surface.

One embodiment of the composition of the wiping unit 274 includes: a web cartridge, which accommodates the web; an elevator mechanism, which moves the web cartridge upward and downward; and a movement mechanism, which causes the wiping unit 274 to move in the lengthwise direction of the inkjet head 72. Furthermore, one embodiment of the composition of the web cartridge includes: a web feed roll and a web take-up roll, which are accommodated inside a frame; a pressing roller, which presses the web against the nozzle surface 72A of the inkjet head 72; and a pair of drive rollers, which drive and convey the web.

In this composition, the web feed roll is a roll of unused web that is wound in the form of the roll, and the web paid out from the web feed roll is wound up onto the pressing roller, passed through the pair of drive rollers, and taken up onto the web take-up roll.

A suitable tension is applied to the web between the web feed roll and the web take-up roll by the pressing roller and the drive rollers, and the web is pressed against the nozzle surface 72A of the inkjet head 72 in the portion corresponding to the pressing roller.

It is desirable that the feed direction of the web is the opposite direction to the direction of movement of the inkjet head 72 during the wiping and cleaning. By conjointly driving the drive rollers and the shaft of the winding roll in accordance with the movement of the inkjet head 72, a wiping action is carried out by the web while the web is wound up onto the web take-up roll.

The elevator mechanism has an elevator platform, which is capable of moving upward and downward, and the web cartridge is disposed on the elevator platform. By controlling a drive device such as a motor of the elevator mechanism, it is possible to control the contact/non-contact state of the web with respect to the nozzle surface 72A.

Furthermore, the cleaning apparatus 200 is provided with the nozzle cap 276 (see FIG. 5), and the nozzle cap 276 is a cap for covering the nozzle surface 72A of the inkjet head 72, and may also be used as an ink receptacle when ink of increased viscosity is sucked from the nozzles (see FIGS. 2A to 2C) by setting the exterior of the nozzle surface 72A to a negative pressure, or a dummy jet is performed to eject ink in dummy from the nozzles (this may also be referred to as preliminary ejection, purging, blank ejection, or the like).

The liquid receptacle 215 is arranged on the lower side of the cleaning liquid pillar generation unit 214 and has a function for receiving the cleaning liquid and the adhering matter that has dropped down from the nozzle surface 72A, and a channel and a pump for sending the waste liquid to a waste ink tank (not shown) are connected to the bottom portion of the liquid receptacle 215.

### <Description of the Control Block>

The head cleaning unit 200 described above is controlled on the basis of the control signals sent to the maintenance control unit 179 from the system controller 172 shown in FIG. 4. More specifically, the maintenance control unit 179 in FIG. 4 controls the movement timing and the movement speed of the inkjet head 72 in the processing region of the head cleaning unit 200, on the basis of the control signals from the system controller 172, as well as controlling the driving speed of the cleaning liquid pump 213 (flow speed of the cleaning liquid), the driving of conveyance of the web of the wiping unit 274, the elevator mechanism of the web, and the like.

Furthermore, the maintenance control unit 179 also has a function for controlling the operations of the respective units when carrying out other maintenance processing, such as sucking of ink of increased viscosity, dummy jets, and the like.

### <Relationship Between Height of Cleaning Liquid Pillars and Flow Speed of Cleaning Liquid>

The following Table 1 shows the relationship between the flow speed of the cleaning liquid supplied to the cleaning liquid pillar generation unit 214 and the height h of the cleaning liquid pillars 217.

TABLE 1

| Flow speed | Height of liquid |
|---|---|
| (ml/min) | pillar (mm) |
| 37.5 | 0.7 |
| 50.0 | 0.8 |
| 75.0 | 1.0 |

As shown in Table 1, when the flow speed (ml/min) of the cleaning liquid is raised, the height h (mm) of the cleaning liquid pillars 217 becomes greater. More specifically, the height h of the cleaning liquid pillars 217 is determined uniformly by the flow speed of the cleaning liquid, and by providing an application height of the inkjet head at a position that is relatively lower than the height h of the cleaning liquid pillar 217, it is possible to achieve stable application of the cleaning liquid of the overlapped volume.

In other words, the clearance between the inkjet head 72 and the cleaning liquid pillar generation unit 214 is assessed by measurement, or the like, and stable application of the cleaning liquid to the nozzle surface 72A can be achieved by adjusting the output (driving speed) of the pump 213 so as to achieve a flow rate corresponding to the clearance.

In the composition shown in FIG. 6, slight pulsation occurs in the cleaning liquid pillars 217 due to the cleaning liquid pump 213. In cases of this kind, it is possible to eliminate the pulsation of the cleaning liquid pillars 217 by installing a damper in the supply channel 218 of the cleaning liquid.

In order to achieve more stable application of the cleaning liquid, it is also possible to achieve stable application of the cleaning liquid by adjusting the flow speed of the cleaning liquid using a liquid head pressure differential, instead of adjusting the flow speed of the cleaning liquid by means of the pump.

FIG. 8 is an approximate schematic diagram of a head cleaning unit 200′ (cleaning liquid application unit 210′) employing a method that adjusts the flow speed of the cleaning liquid by using the liquid head pressure differential. The head cleaning unit 200′ in FIG. 8 has a mechanism (not shown) for altering the height H (liquid head differential) of the cleaning liquid tank 212 with respect to the cleaning liquid pillar generation unit 214, and the flow speed of the cleaning liquid is regulated by altering the liquid head pressure differential of the cleaning liquid tank 212 with respect to the cleaning liquid pillar generation unit 214.

In the inkjet recording apparatus 10 shown in FIG. 1, the head cleaning unit 200 shown in FIG. 6 (or 200′ shown in FIG. 8) is disposed in the vicinity of the print unit 16 in FIG. 1. The inkjet head 72 is moved to the arrangement position of the head cleaning unit 200 by means of a head movement mechanism (the mechanism including the ball screw 284 in FIG. 5), whereupon the cleaning process of the nozzle surface 72A is then carried out by moving the inkjet head 72 in the processing region of the cleaning apparatus 200.

In the apparatus composition including the plurality of inkjet heads 72M, 72K, 72C and 72Y as shown in FIG. 1, it is possible to adopt a composition in which a plurality of head cleaning units 200 are provided in equal number to the inkjet heads 72M, 72K, 72C and 72Y, and the cleaning process is carried out simultaneously in all of the inkjet heads 72M, 72K, 72C and 72Y, or a composition in which at least one head cleaning unit 200 is provided in smaller number than the inkjet heads 72M, 72K, 72C and 72Y, and the cleaning process is carried out progressively in all of the inkjet heads 72M, 72K, 72C and 72Y while moving the inkjet heads 72M, 72K, 72C and 72Y.

### <Description of Cleaning Liquid Pillar Generation Unit 214>

Next, the structure of the cleaning liquid pillar generation unit 214 shown in FIG. 6 is described in further detail. FIG. 9 is a diagram of an upper surface 214A of the cleaning liquid pillar generation unit 214, which faces the nozzle surface 72A (see FIG. 6). As shown in FIG. 9, the upper surface 214A of the cleaning liquid pillar generation unit 214 has a structure in which the cleaning liquid nozzles 220 are arranged equidistantly at a prescribed arrangement pitch Pn through a length corresponding to the breadth D of the inkjet head. More specifically, the cleaning liquid nozzles 220 shown in FIG. 9 are arranged correspondingly to the breadth D of the inkjet head 72, and are of a flat nozzle arrangement having the equidistant arrangement pitch and having the dimension that is the same with or exceeds the breadth D of the inkjet head 72.

FIG. 9 shows an example of a mode where the cleaning liquid nozzles 220 are arranged in a substantially parallel to the breadthways direction of the inkjet head 72. It is also possible to adopt a mode in which the cleaning liquid nozzles 220 are arranged in an oblique direction with respect to the breadthways direction of the inkjet head 72. More specifically, when the cleaning liquid nozzles 220 are aligned on a line of a length L along a direction forming an angle α with respect to the breadthways direction of the inkjet head 72, it is sufficient that the relationship L'cos α≧D is satisfied.

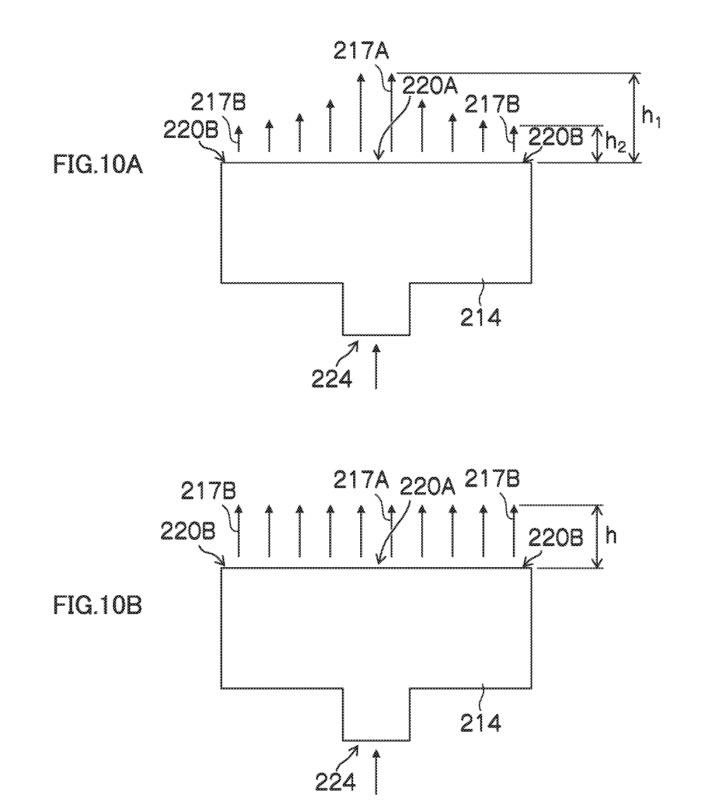

There may be variations in the shape of the cleaning liquid pillars 217 as shown in FIG. 10A in the cleaning liquid pillar generation unit 214 having the above-described structure, due to the differences in the flow channel lengths from an inlet port 224 to the respective cleaning liquid nozzles 220 (see FIG. 9). In FIG. 10A, the inlet port 224 is arranged in substantially the central portion of the cleaning liquid pillar generation unit 214 in the widthwise direction thereof. Then, of the cleaning liquid nozzles 220, the cleaning liquid nozzles 220B nearer to the end portions in the widthwise direction than the cleaning liquid nozzles 220A in the central portion in the widthwise direction have a longer flow channel length from the inlet port 224, and the height h₁ of the cleaning liquid pillars 217A formed in the central portion of the arrangement direction of the cleaning liquid nozzles 220 in the cleaning liquid pillar generation unit 214 is greater than the height h₂ of the cleaning liquid pillars 217B formed in the end portions.

It is then desirable that restrictors are arranged in the flow channels which connect with the respective cleaning liquid nozzles 220, so as to avoid the above-described height variations of the cleaning liquid pillars 217 and to create the cleaning liquid pillars 217A and 217B of equal height h from the cleaning liquid nozzles 220A in the central portion through to the cleaning liquid nozzles 220B in the respective end portions as shown in FIG. 10B.

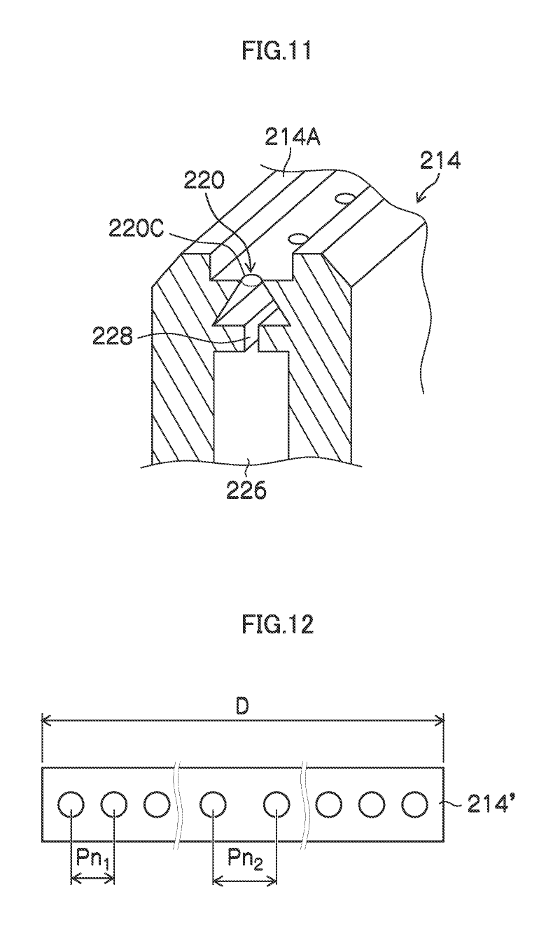

FIG. 11 is a cross-sectional perspective diagram showing an enlarged view of the vicinity of the upper surface 214A of the cleaning liquid pillar generation unit 214. In the cleaning liquid pillar generation unit 214 shown in FIG. 11, apertures 220C of the cleaning liquid nozzles 220 having a substantially conical shape are formed in a recess section of the upper surface 214A, and the cleaning liquid nozzles 220 are provided with a common restrictor 228, which has a slit shape, directly below the respective cleaning liquid nozzles 220.

More specifically, the restrictor 228 is a long thin slit formed following the direction of arrangement of the cleaning liquid nozzles 220 in a position opposing the apertures 220C of the cleaning liquid nozzles 220, and having a width less than the diameter of the cleaning liquid nozzles 220. The flow channel 226 has a structure which connects to the cleaning liquid nozzles 220 through the restrictor 228.

By providing the restrictor 228 as shown in FIG. 11, the pressure differential between the respective cleaning liquid nozzles 220 is cancelled out due to the pressure loss created by the restrictor 228, and a uniform pressure is applied to the respective cleaning liquid nozzles 220.

As a further method for avoiding the height variations of the cleaning liquid pillars 217, it is possible to adjust the arrangement pitch of the cleaning liquid nozzles 220 in such a manner that the pitch in the vicinity of the end portions in the arrangement of the cleaning liquid nozzles 220 is smaller than the arrangement pitch in the vicinity of the central portion.

A cleaning liquid pillar generation unit 214′ shown in FIG. 12 is composed so as satisfy the relationship Pn₁<Pn₂ between the arrangement pitch Pn₁ of the cleaning liquid nozzles 220 in the respective end portions and the arrangement pitch Pn₂ of the cleaning liquid nozzles 220 in the central portion in the arrangement of the cleaning liquid nozzles 220. The arrangement pitch Pn₂ of the cleaning liquid nozzles 220 in the central portion with respect to the arrangement pitch Pn₁ of the cleaning liquid nozzles 220 in the end portions is decided appropriately in accordance with the pressure differential.

In the mode shown in FIG. 12, the arrangement pitches of the cleaning liquid nozzles 220 are differentiated in two levels, but the arrangement pitches of the cleaning liquid nozzles 220 may also be differentiated in a greater number of levels.

According to this mode, it is possible to reduce the height variation of the cleaning liquid pillars 217 which is produced between the central portion and the end portions in the alignment direction of the cleaning liquid nozzles 220, and the cleaning liquid can be applied uniformly to the nozzle surface 72A of the inkjet head 72.

### Modified Embodiments

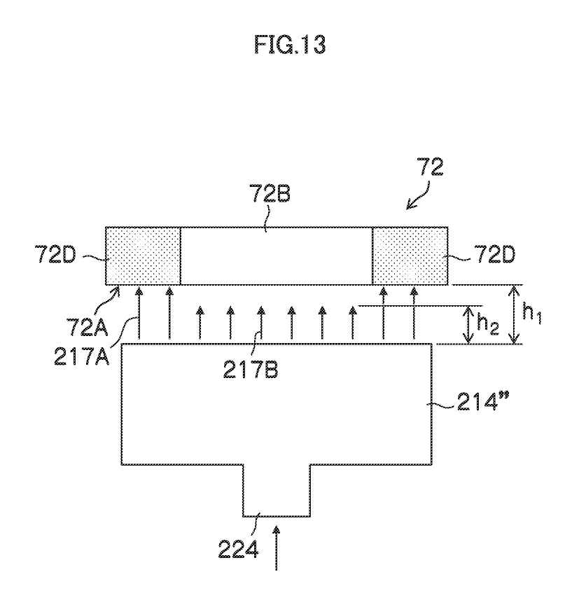

Next, a head cleaning unit (cleaning liquid application unit) according to a modified embodiment is described with reference to FIG. 13. A cleaning liquid pillar generation unit 214″ shown in FIG. 13 is composed in such a manner that the amounts of cleaning liquid applied are differentiated in accordance with the liquid-repellencies of the nozzle surface 72A of the inkjet head 72.

The inkjet head 72 has a region (nozzle forming region) 72B having high liquid-repellency, where nozzles are formed, and a region (face plate) 72D having low liquid-repellency, and the low liquid-repellency region 72D is more liable to become soiled than the high liquid-repellency region 72B. If there are portions having different liquid-repellencies on the nozzle surface 72A in this way, then it is possible to apply a greater amount of the cleaning liquid to the low liquid-repellency region 72D, which is more liable to soiling, by intentionally differentiating the heights of the cleaning liquid pillars 217 locally by adjusting the diameters and arrangement pitches of the cleaning liquid nozzles 220 (see FIG. 9).

More specifically, as shown in FIG. 13, by adopting a composition whereby the relationship between the height h₁ of the cleaning liquid pillars 217A corresponding to the low liquid-repellency regions 72D in the end portions in the breadthways direction of the inkjet head 72 and the height h₂ of the cleaning liquid pillars 217B corresponding to the high liquid-repellency region 72B of the inkjet head 72 is h₁>h₂, it is possible to achieve a desirable application of the cleaning liquid corresponding to the liquid-repellencies of the nozzle surface 72A of the inkjet head 72.

Instead of or in conjunction with the adjustment of the aperture diameters and the arrangement pitches of the cleaning liquid nozzles 220 (see FIG. 9), it is possible to divide the interior of the cleaning liquid pillar generation unit 214″ in such a manner that the flow speeds of the cleaning liquid supplied to the cleaning liquid nozzles 220 are varied in accordance with the high liquid-repellency region 72B and the low liquid-repellency region 72D of the inkjet head.

Although FIGS. 9, 11 and 12 show the mode where the cleaning liquid nozzles 220 are arranged in a single row, it is also possible to arrange the cleaning liquid nozzles 220 in a plurality of rows. By increasing the number of cleaning liquid nozzles 220, it is possible to increase the amount of the cleaning liquid applied per unit time.

In the present embodiments, the mode has been described in which the head cleaning unit 200 is appended to the inkjet recording apparatus 10; however, it is also possible to compose a maintenance apparatus for the inkjet head by separating the head cleaning unit 200 from the inkjet recording apparatus 10.

Furthermore, in the present embodiments, the inkjet recording apparatus has been described which records a color image by ejecting and depositing color inks onto a recording medium as one example of an image forming apparatus; however, the present invention can also be applied to an image forming apparatus which forms a prescribed pattern shape on a substrate by means of a resin liquid, or the like, in order, for instance, to form a mask pattern or to print wiring of a printed wiring board.

### Appendix

As has become evident from the detailed description of the embodiments given above, the present specification includes disclosure of various technical ideas below.

It is preferable that an inkjet head cleaning apparatus comprises: a cleaning liquid application device including a cleaning liquid nozzle which applies cleaning liquid to a liquid ejection surface of an inkjet head; a cleaning liquid supply device which supplies the cleaning liquid to the cleaning liquid nozzle; and a flow speed adjustment device which adjusts a flow speed of the cleaning liquid supplied from the cleaning liquid supply device to the cleaning liquid nozzle in such a manner that a pillar of the cleaning liquid emitted from the cleaning liquid nozzle makes contact with the nozzle surface of the inkjet head.

According to this mode, since the cleaning liquid is applied by bringing a pillar of the cleaning liquid into contact with the liquid ejection surface of the inkjet head, the flow speed of the cleaning liquid in the direction perpendicular to the liquid ejection surface is practically zero, and therefore breakdown of the meniscus inside the nozzles formed in the liquid ejection surface is prevented and stable printing performance of the inkjet head is maintained. Furthermore, by adjusting the flow speed of the cleaning liquid supplied to the cleaning liquid nozzle, it is possible readily to adjust the height of the pillar of the cleaning liquid, and therefore simplification of the assembly and adjustment of the maintenance unit can be expected.

The inkjet head is a liquid ejection head which ejects liquid from nozzles (apertures) arranged in the liquid ejection surface, using an inkjet method, and one embodiment of the composition of such a head includes liquid chambers connected to the nozzles and pressure applying devices which apply pressure to the liquid inside the liquid chambers. Furthermore, the liquid to be ejected from the inkjet head includes various liquids, such as color inks which form (record) an image on a recording medium, or a resin liquid which forms a prescribed pattern on a substrate, or the like.

Preferably, the flow speed adjustment device includes a pump arranged between the cleaning liquid supply device and the cleaning liquid application device, and adjusts the flow speed of the cleaning liquid supplied to the cleaning liquid nozzle by means of the pump.

In this mode, the height of the pillar of the cleaning liquid becomes greater when the driving speed of the pump is increased, and the height of the pillar of the cleaning liquid becomes lower when the driving speed of the pump is lowered.

Alternatively, it is also preferable that the flow speed adjustment device adjusts the flow speed of the cleaning liquid supplied to the cleaning liquid nozzle by means of a liquid head pressure differential between the cleaning liquid supply device and the cleaning liquid application device.

According to this mode, it is possible to achieve more stable application of the cleaning liquid, without producing pulsations in the pillar of the cleaning liquid pillar.

Preferably, the cleaning liquid application device includes a plurality of cleaning liquid nozzles arranged along a prescribed alignment direction and has a flow channel connecting to the cleaning liquid nozzles; and the flow channel has a restrictor having a width less than a diameter of each of the cleaning liquid nozzles.

According to this mode, it is possible to reduce the height variations of the cleaning liquid pillars produced by the differences in the flow channel resistances of the respective cleaning liquid nozzles, and the cleaning liquid is applied uniformly to the whole of the liquid ejection surface.

Preferably, the restrictor includes a groove formed along the alignment direction of the cleaning liquid nozzles.

A desirable mode in this respect is one where the restrictors are formed on the plane opposing the apertures of the cleaning liquid nozzles.

Preferably, the cleaning liquid application device has an inlet port through which the cleaning liquid is introduced from the cleaning liquid supply device; a first flow channel resistance from the inlet port to the cleaning liquid nozzles arranged in a first region is larger than a second flow channel resistance from the inlet port to the cleaning liquid nozzles arranged in a second region; and a first interval between the cleaning liquid nozzles arranged in the first region is smaller than a second interval between the cleaning liquid nozzles arranged in the second region.

According to this mode, it is possible to reduce the height variations of the cleaning liquid pillars produced by the differences in the flow channel resistances of the respective cleaning liquid nozzles.

Preferably, the inkjet head cleaning apparatus further comprises: a movement device which causes the inkjet head and the cleaning liquid application device to move relatively to each other, wherein the cleaning liquid application device includes a plurality of cleaning liquid nozzles arranged through a length not shorter than a breadth of the inkjet head.

According to this mode, by moving the cleaning liquid application device just once relatively with respect to the inkjet head, it is possible to apply the cleaning liquid over the whole of the liquid ejection surface of the inkjet head.

In the case of this mode, it is desirable that the inkjet head is moved to a processing region of the inkjet head cleaning apparatus.

It is also preferable that an image recording apparatus comprises: an inkjet head; and an inkjet head cleaning unit which includes: a cleaning liquid application device including a cleaning liquid nozzle which applies cleaning liquid to a liquid ejection surface of an inkjet head; a cleaning liquid supply device which supplies the cleaning liquid to the cleaning liquid nozzle; and a flow speed adjustment device which adjusts a flow speed of the cleaning liquid supplied from the cleaning liquid supply device to the cleaning liquid nozzle in such a manner that a pillar of the cleaning liquid emitted from the cleaning liquid nozzle makes contact with the nozzle surface of the inkjet head.

In this mode, a desirable mode is one where a head movement device which moves the inkjet head to the processing region of the inkjet head cleaning unit is provided, and the inkjet head is moved to the processing region of the inkjet head cleaning unit when carrying out a cleaning process of the liquid ejection surface of the inkjet head.

A desirable mode is one where the cleaning liquid is applied over the whole of the liquid ejection surface by moving the inkjet head in the processing region of the inkjet head cleaning unit.

It is also preferable that a method of cleaning an inkjet head comprises the steps of: adjusting a flow speed of cleaning liquid in such a manner that a pillar of the cleaning liquid comes into contact with a liquid ejection surface of the inkjet head; and applying the cleaning liquid to the liquid ejection surface of the inkjet head through the pillar of the cleaning liquid.

A desirable mode is one further comprising the step of moving the inkjet head to the cleaning processing region, and the step of applying the cleaning liquid to the whole of the liquid ejection surface by moving the inkjet head in the cleaning processing region.

Preferably, the method further comprises the step of wiping away the cleaning liquid having been applied to the liquid ejection surface.

According to this mode, after the cleaning process of the inkjet head, no cleaning liquid is left on the liquid ejection surface.

Desirably, this mode includes the step of moving the inkjet head to a prescribed printing position after the wiping step.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An inkjet head cleaning apparatus, comprising:
a cleaning liquid application device including a cleaning liquid nozzle which applies cleaning liquid to a liquid ejection surface of an inkjet head;
a cleaning liquid supply device which supplies the cleaning liquid to the cleaning liquid nozzle; and
a flow speed adjustment device which adjusts a flow speed of the cleaning liquid supplied from the cleaning liquid supply device to the cleaning liquid nozzle in such a manner that a pillar of the cleaning liquid emitted from the cleaning liquid nozzle makes contact with the nozzle surface of the inkjet head.

2. The apparatus as defined in claim 1, wherein the flow speed adjustment device includes a pump arranged between the cleaning liquid supply device and the cleaning liquid application device, and adjusts the flow speed of the cleaning liquid supplied to the cleaning liquid nozzle by means of the pump.

3. The apparatus as defined in claim 1, wherein the flow speed adjustment device adjusts the flow speed of the cleaning liquid supplied to the cleaning liquid nozzle by means of a liquid head pressure differential between the cleaning liquid supply device and the cleaning liquid application device.

4. The apparatus as defined in claim 1, wherein:
the cleaning liquid application device includes a plurality of cleaning liquid nozzles arranged along a prescribed alignment direction and has a flow channel connecting to the cleaning liquid nozzles; and
the flow channel has a restrictor having a width less than a diameter of each of the cleaning liquid nozzles.

5. The apparatus as defined in claim 4, wherein the restrictor includes a groove formed along the alignment direction of the cleaning liquid nozzles.

6. The apparatus as defined in claim 4, wherein:
the cleaning liquid application device has an inlet port through which the cleaning liquid is introduced from the cleaning liquid supply device;
a first flow channel resistance from the inlet port to the cleaning liquid nozzles arranged in a first region is larger than a second flow channel resistance from the inlet port to the cleaning liquid nozzles arranged in a second region; and
a first interval between the cleaning liquid nozzles arranged in the first region is smaller than a second interval between the cleaning liquid nozzles arranged in the second region.

7. The apparatus as defined in claim 1, further comprising:
a movement device which causes the inkjet head and the cleaning liquid application device to move relatively to each other,
wherein the cleaning liquid application device includes a plurality of cleaning liquid nozzles arranged through a length not shorter than a breadth of the inkjet head.

8. An image recording apparatus, comprising:
an inkjet head; and
an inkjet head cleaning unit which includes: a cleaning liquid application device including a cleaning liquid nozzle which applies cleaning liquid to a liquid ejection surface of an inkjet head; a cleaning liquid supply device which supplies the cleaning liquid to the cleaning liquid nozzle; and a flow speed adjustment device which adjusts a flow speed of the cleaning liquid supplied from the cleaning liquid supply device to the cleaning liquid nozzle in such a manner that a pillar of the cleaning liquid emitted from the cleaning liquid nozzle makes contact with the nozzle surface of the inkjet head.

9. The apparatus as defined in claim 8, wherein the flow speed adjustment device includes a pump arranged between the cleaning liquid supply device and the cleaning liquid application device, and adjusts the flow speed of the cleaning liquid supplied to the cleaning liquid nozzle by means of the pump.

10. The apparatus as defined in claim 8, wherein the flow speed adjustment device adjusts the flow speed of the cleaning liquid supplied to the cleaning liquid nozzle by means of a liquid head pressure differential between the cleaning liquid supply device and the cleaning liquid application device.

11. The apparatus as defined in claim 8, wherein:
the cleaning liquid application device includes a plurality of cleaning liquid nozzles arranged along a prescribed alignment direction and has a flow channel connecting to the cleaning liquid nozzles; and
the flow channel has a restrictor having a width less than a diameter of each of the cleaning liquid nozzles.

12. The apparatus as defined in claim 11, wherein the restrictor includes a groove formed along the alignment direction of the cleaning liquid nozzles.

13. The apparatus as defined in claim 11, wherein:
the cleaning liquid application device has an inlet port through which the cleaning liquid is introduced from the cleaning liquid supply device;
a first flow channel resistance from the inlet port to the cleaning liquid nozzles arranged in a first region is larger than a second flow channel resistance from the inlet port to the cleaning liquid nozzles arranged in a second region; and
a first interval between the cleaning liquid nozzles arranged in the first region is smaller than a second interval between the cleaning liquid nozzles arranged in the second region.

14. The apparatus as defined in claim 8, further comprising:
a movement device which causes the inkjet head and the cleaning liquid application device to move relatively to each other,
wherein the cleaning liquid application device includes a plurality of cleaning liquid nozzles arranged through a length not shorter than a breadth of the inkjet head.

15. A method of cleaning an inkjet head, comprising the steps of:
adjusting a flow speed of cleaning liquid in such a manner that a pillar of the cleaning liquid comes into contact with a liquid ejection surface of the inkjet head; and
applying the cleaning liquid to the liquid ejection surface of the inkjet head through the pillar of the cleaning liquid.

16. The method as defined in claim 15, further comprising the step of wiping away the cleaning liquid having been applied to the liquid ejection surface.
